(19) United States
(12) Patent Application Publication
(10) Pub. No.: US 2013/0060610 A1
(43) Pub. Date: Mar. 7, 2013

(54) METHODS AND SYSTEMS OF USING PERSONALIZED MULTI-DIMENSIONAL AVATAR (PMDA) IN COMMERCE

(71) Applicant: Michael R. McGurk, Sudbury, MA (US)

(72) Inventor: Michael R. McGurk, Sudbury, MA (US)

(21) Appl. No.: 13/697,009

(22) PCT Filed: May 9, 2011
(86) PCT No.: PCT/US11/35755

§ 371 Date: Nov. 8, 2012

Related U.S. Application Data
(60) Provisional application No. 61/332,889, filed on May 10, 2010.

(51) Int. Cl. G06Q 30/00; G06Q 10/06

(52) U.S. Cl. 705/7.36; 705/26.63

(57) ABSTRACT

A personalized multi-dimensional avatar (PMDA) to represent individuals are used for dynamically searching for elements in a computer-based commerce system that matches a subject element to a target element. In one aspect, permissioning preferences of the represented individual control contacting the represented individual and/or using the PMDA specifications. In another aspect, desired items and sources of the items are identified to individuals. In another aspect, the PMDAs are used to identify desired customers.

### CROSS-REFERENCE TO RELATED APPLICATION

The present application claims the benefit of the filing date of U.S. Provisional Patent Application No. 61/332,889, filed May 10, 2010, currently pending, the entire disclosure of which is incorporated herein by reference.

### FIELD

The present invention relates to the field of commerce. The term “commerce” as used herein shall be broadly construed to mean all forms of the purchase and sale of goods and services.

### BACKGROUND

On-line or web-based shopping has revolutionized commerce, and in particular how customers and businesses interact and do business with each other. Nonetheless, the buying experience for customers (and consequently for businesses that care) can be time consuming, frustrating, and even expensive.

The buying experience can be time consuming for the customer because, for among other reasons, the customer needs to search numerous web sites to find what he is looking for, then figure out exactly what product to buy and whether it will fit, which many times involves knowing a customer's specific body size and type and/or other personal preferences. The buying experience can be both time consuming and frustrating for the customer because many times the purchased product does not properly fit, is not the right type or color, or just does not look good; or it otherwise does not satisfy the finicky customer's tastes. The buying experience can also be expensive for the customer because, many times, the customer is required to pay the costs of shipping for the purchased goods and for any returns, thus making the costs of doing business with a particular retail site even more expensive.

The buying experience can be frustrating, time consuming, and expensive for the business because it needs to replace or accept return of the purchased product, have customer service deal with unhappy customers, and pay for return, warehousing and inventory costs, and even potential lost business opportunities. Many companies simply throw the returns away or donate them to charities because they cannot be resold.

Sometimes, it is difficult or nearly impossible to shop in person or on-line for certain types of goods in commerce, including specialty clothing such as bras, panties, maternity clothes, infant and toddler/children's clothing, hats, and shoes, to name a few. Extremely muscular, tall, or short people have a difficult time finding clothes that fit. Lack of time and poor geography also make on-line shopping the only real option for some.

Some handicapped persons, for physical or other reasons, may not be able to or want to travel to stores to shop for goods. In addition, it may be very difficult and time consuming for some handicapped persons to try on clothes outside of their homes.

It can be a challenge to research and shop on-line for automobiles, trucks, motorcycles and bicycles, as well as many other items. And finally, sometimes searching on-line results in far too many options, which can overwhelm the customer.

Even with the information that is available over the Internet, it can also be a challenge for customers to identify retailers who carry goods and services that at least partially match the customer's requirements. Conversely, it can be a challenge for retailers to find prospective customers.

Almost all of these problems are at least partially caused by the lack of sufficient data on the one hand regarding the goods or services being sought or researched (i.e., the retailer or manufacturer or the source) and the lack of sufficient data on the other hand regarding the individual(s) doing the research (i.e., the customer or buyer). There is a need to substantially improve the customer and business experiences involving computer based systems used in the furtherance of commerce.

### SUMMARY

One component of the solution is a personalized multi-dimensional avatar (PMDA) to be used in commerce to facilitate searching for goods or services or other elements of a computer-based commerce system, using personalized criteria inputted by the customer, which criteria can be modified and/or updated continuously to refine and update the search results until the desired goods are identified.

By way of example only, depending on the search criteria used, the initial search results may identify only those retail stores that carry the type of goods meeting the search criteria (a retail level search). Alternatively, the initial search results may identify every good in the world (available on-line) that meet the search criteria (product level search). For the retail level search, the PMDA may then be used for each retailer selected to further search for goods available from that retailer that meet the initial search criteria or updated criteria. For the product level search, the PMDA may then be used to further search all the products identified by the initial search criteria or updated criteria. In both cases, the search criteria may be updated iteratively until the PMDA (customer) locates the items being searched for, and decides to purchase them.

In the broadest sense, the present invention relates generally to the use of a PMDA, created by its owner, in commerce to search for and buy desired goods. The goods identified are based on inputted criteria used to create the PMDA. Also, retailers or other third parties may search for a PMDA, based on inputted criteria that match the PMDA's inputted criteria, in an effort to solicit the PMDA's owner to buy goods that meet the PMDA inputted criteria. And, PMDAs may search for each other based on inputted criteria, to, among other things, share information about sales, desirable retailers, goods bought on-line, etc.

Thus, systems and methods for dynamically searching for elements in a computer-based commerce system are herein described. In one embodiment, elements of the computer-based commerce system may be individuals, retailers, and items. The individuals may further be humans or animals, such as pets, and the items may be individual goods or services. The elements in the computer-based commerce system are searched by receiving, from a portal, search criteria related to a desired item and a personalized multi-dimensional avatar (PMDA) for an individual. The specifications of the PMDA may be characteristics of the individual, preferences of the individual, and/or measurements of parts of the individual. A search engine may identify at least one target item having a specification that is at least partially compatible with at least one of the search criteria and at least one specification of the PMDA. Sources for the target items are also identified. A content server may then present search results for review by a party seeking the desired item. The search results may be information about the target items and information about the sources of the target items.

In further embodiments, a virtual mall containing links to the sources is created from the search results to facilitate future access to the sources. In still further embodiments, at least some of the search results are forwarded to a software program in a mobile device; and, based on the search results, a geographic location of a first source of the desired item is identified to a party in order to identify a proximity of the first source to the party. In still further embodiments, an image of a first target item is displayed with the PMDA in order to display a simulation of how the first target item would operate with the individual. The image may be rendered translucent to facilitate viewing of the first target item relative to the PMDA.

In another embodiment, methods and systems are described for dynamically searching for potential customers who seek elements in commerce. The searching may comprise receiving, from a portal, search criteria related to a desired potential customer. A search engine may search for the desired potential customer by searching a set of PMDAs representing a set of individuals. The PMDAs have specifications such as those described above. A compatible PMDA may be identified as representing the desired potential customer when its specification is at least partially compatible with at least one of the search criteria. A content server may then present search results for review by a party seeking the desired potential customer. The search results may have information about the individual represented by the compatible PMDA.

In a further embodiment, the search results identify a set of individuals with PMDAs with specifications that are at least partially compatible with at least one of the search criteria, and a business plan is developed based on the search results. In still further embodiments, the business plan may be an inventory plan, a marketing plan, or a sales plan. In a further embodiment, products or services are developed that are tailored to the specifications of the PMDAs associated with the search results.

In another embodiment, methods and systems are described for dynamically searching for elements in a computer-based commerce system that matches a subject element to a target element. Specifications of the subject element and search criteria related to a desired target element are received from at least one portal. The subject element and/or the desired target element may be an individual represented by a PMDA having a specification as disclosed above.

A search engine may search a database containing data related to PMDAs for the desired target element. The database search may retrieve data associated with the elements of the computer-based commerce system and compare specifications of the PMDA with the search criteria and with specifications of other elements of the computer-based commerce system. In a further embodiment, both the subject element and the desired target element comprise individuals, and the specifications of PMDAs are compared to identify individuals having PMDAs with specifications that at least partially match.

When specifications of the PMDA are matched with specifications of other elements of the computer-based commerce system, the searching may identify a first target element having specifications that are at least partially compatible with at least one of the specifications of the subject element and at least one of the search criteria, In a further embodiment, search results may be refined by updating the search criteria, updating the specifications of the subject element; and/or inputting new search criteria; and updating the PMDA. A content server may present search results for review by a party seeking the desired element, with the search results having information about the desired target element.

Permissioning preferences of the represented individual may also be received. The permissions may encompass an individual's preferences for being contacted or the uses to which his PMDA may be put. They may include preferences as to the type of access to the PMDA that is allowed to the search engine. They may also include preferences of the represented individual as to the type of contact with the represented individual that is allowed to parties. Contacting the represented individual or using the specifications for the PMDA for the represented individual may be based on the permissioning preferences.

### DEFINITIONS

The terms used herein shall be given their ordinary and customary definitions in the context in which they are used, except as otherwise noted.

The term “computer” or “computer system” shall mean any electronic medium containing a processor that may be used to implement and benefit from the above technology, including laptop computers, mobile phones, other wireless platforms, PDA's (such as the BlackBerry™ system available from Research In Motion, Waterloo, Ontario, Canada, and the iPhone™ system available from Apple Computer, Inc. of Cupertino, Calif.), web-based applications, the internet, social networking sites and the like. Generally, any electronic medium that allows communication between a computer based PMDA and a third party computer based system involved in commerce, including communication between two or more PMDAs. In addition, a “computer” or “computer system” includes the use of cloud computing technologies that permit the remote use computers for storage and other functions. For example, it allows a web-page owner to run his/her site remotely using third party cloud computing technologies/services.

The terms “third party,” “retailer,” “retail system” “advertiser” and “individual” may be interchangeable as used herein in some contexts and shall include the selling of goods and/or services in commerce, including individuals reselling products on-line.

The term “individual” shall mean generally a person or human being, but may be broadly interpreted to encompass animals as well.

The term “avatar” shall mean a graphical image that represents an individual, such as a person or an animal, in a virtual reality environment or in cyberspace.

The term “personal multi-dimensional avatar” or “PMDA” shall mean an avatar that represents the individual with a multi-dimensional figure, including a 3D figure, in which the figure is based on the individual's dimensions and/or shape and is capable of mimicking at least the individual's personal dimensions and/or shape.

The term “criteria” shall mean the information associated with the individual that may be used to create or otherwise update his or her PMDA, and that may be used to evaluate or test the suitability or desirability to the individual of items in commerce or of retailers or the suitability or desirability of individuals to a third party or retailer. The information that forms the criteria may include, for example, information about the individual's dimensions and/or shape or information about the individual's preferences,

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1a is a block diagram of an exemplary commerce system 10a;

FIG. 1b is a block diagram of an exemplary computer-based commerce system 10b employing PMDAs to represent the customers shown in FIG. 1a;

FIG. 1c is block diagram of a computer-based commerce system 100 according to one exemplary embodiment;

FIG. 2 is a block diagram of an exemplary content server 155 of the computer-based commerce system 100 of FIG. 1c;

FIG. 3a is a block diagram of an exemplary customer system 135a for use in the computer-based commerce system 100 of FIG. 1c;

FIG. 3b is a block diagram of a scanner, PMDA components, and another exemplary customer system 135b for use in the computer-based commerce system 100 of FIG. 1c;

FIG. 4 is a block diagram of an exemplary item server 125 of the computer-based commerce system 100 of FIG. 1c;

FIG. 5 is a block diagram of an exemplary retail server 115 of the computer-based commerce system 100 of FIG. 1c;

FIG. 6 is a flowchart depicting an exemplary process 600 for dynamically searching for items in a computer based commerce system according to one exemplary embodiment;

FIG. 7 is a flowchart depicting one embodiment of the stage 630 for using a search engine to search for the desired item;

FIG. 8 is a flowchart depicting an exemplary process 800 for dynamically searching for potential customers in a computer based commerce system according to one exemplary embodiment;

FIG. 9 is a flowchart depicting one embodiment of the stage 830 for using a search engine to search for the desired potential customer;

FIG. 10 is a flowchart depicting an process 1000 for dynamically searching for elements in a computer based commerce system according to one exemplary embodiment;

FIG. 11 is a flowchart depicting one embodiment of the stage 1040 for using a search engine to search for the desired element;

FIG. 12 is a flowchart depicting a process 1200 for creating a PMDA, according to one exemplary embodiment.

FIG. 13 is a flowchart depicting a process 1300 for using a PMDA to communicate with a retailer and, optionally, purchase product(s) from the retailer, according to another exemplary embodiment.

FIG. 14 is a flowchart depicting a process 1400 for using a PMDA to search for a retailer(s) and, optionally, purchase a product(s), according to another exemplary embodiment.

FIG. 15 is a flowchart depicting a process 1500 for searching by a retailer for PMDAs and, optionally, for using a PMDA to purchase product from the retailer, according to another exemplary embodiment.

FIG. 16 is a flowchart depicting a process 1600 for using PMDAs to search for each other, according to another exemplary embodiment.

FIGS. 17 and 18 are flowcharts depicting processes 1700, 1800, respectively, for creating specialized personalized avatars, according to other exemplary embodiments.

FIG. 19 is a flowchart depicting a process 1900 for creating a personalized avatar by use of a scanner(s) and, optionally, manual data entry.

### DETAILED DESCRIPTION OF EXEMPLARY EMBODIMENTS

Reference will now be made in detail to the present exemplary embodiments, examples of which are illustrated in the accompanying drawings. Wherever possible, the same reference numbers will be used throughout the drawings to refer to the same or like parts.

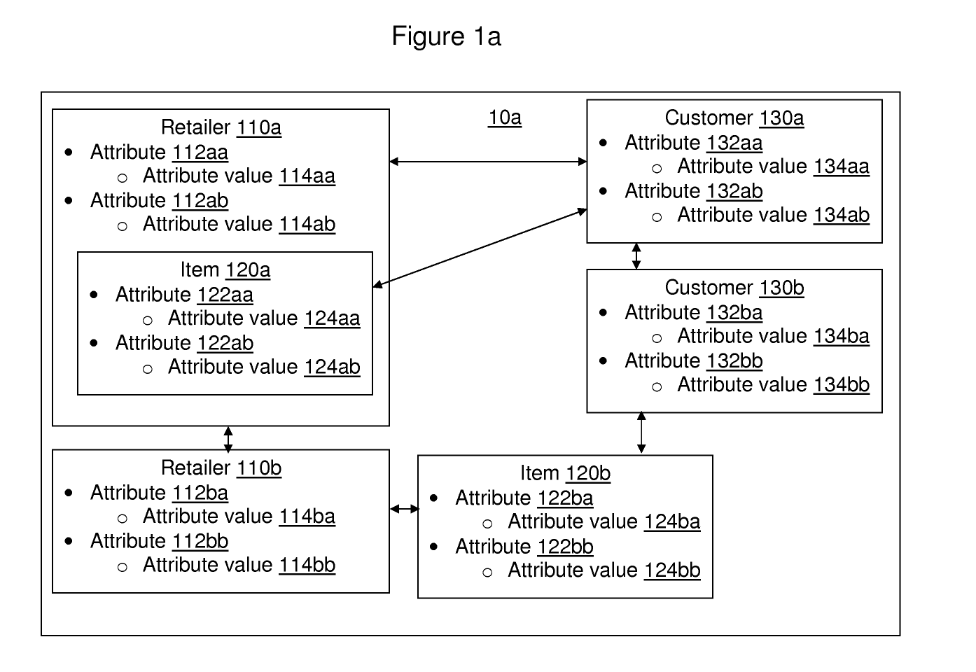

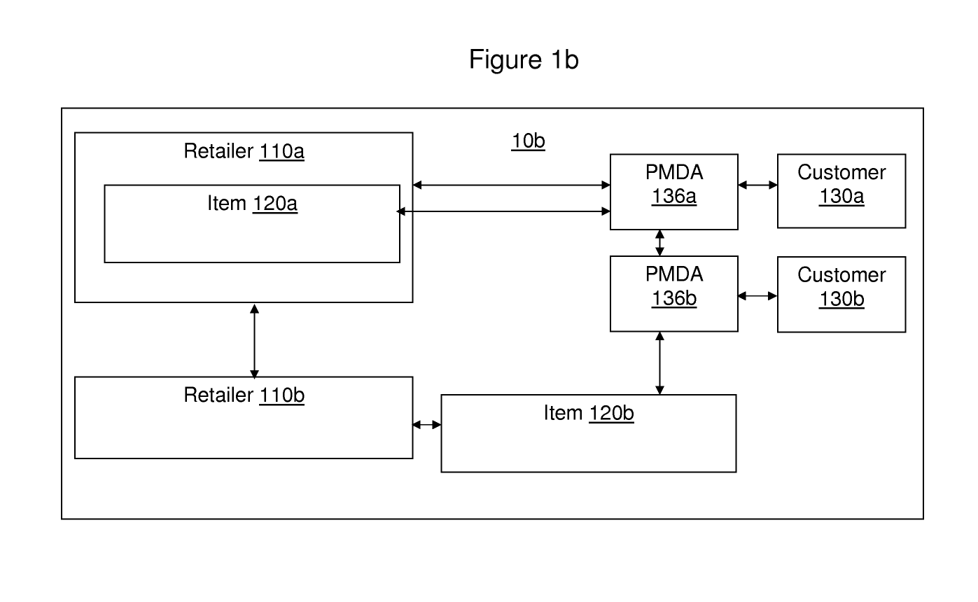

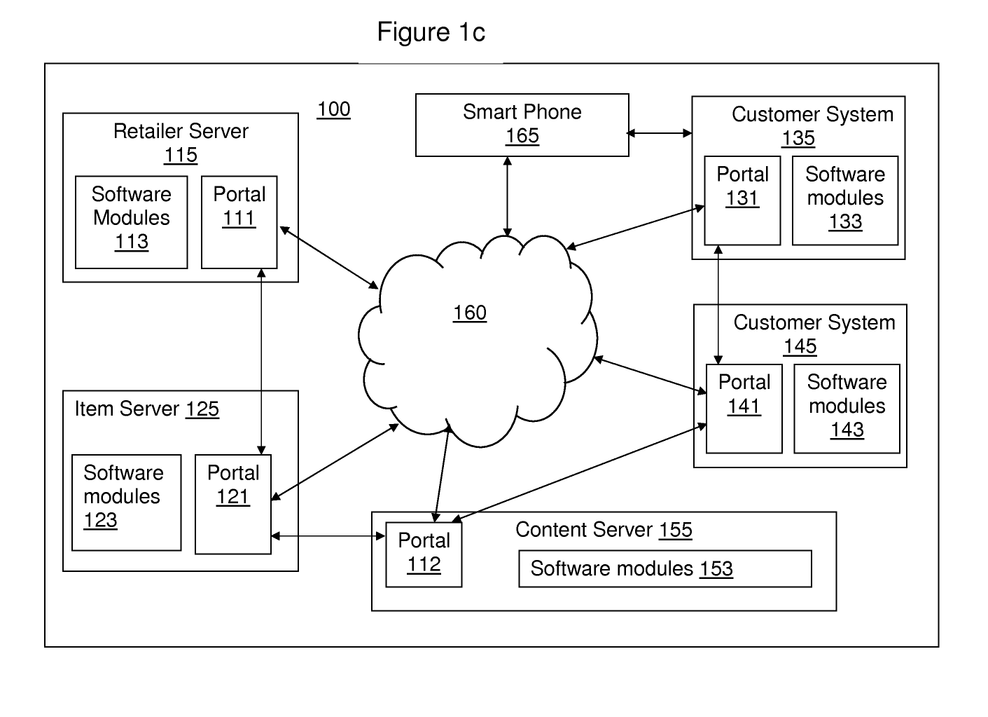

FIG. 1a shows portions of an exemplary commerce system 10a. Categories of elements in the commerce system 10a may be, for example, retailers 110a, 110b; items 120a, 120b; and customers 130a, 130b. Items may be associated with specific retailers, such as item 120a may be associated with and available through retailer 110a. Alternatively, items such as item 110b may be available from a non-retailer source, such as a manufacturer, a wholesaler, or a distributor.

Specifications may be defined for the elements in the commerce system 10a. An attribute may be any defining characteristic, such as type of item, color of item, or size of item. In addition, attributes may be hierarchical. For example, the apparel attribute may have sub-attributes, such as men's, women's, and children's apparel, and each of those sub-attributes may have further sub-attributes, such as pants, shirts, and accessories. Each attribute may have a set of values that may be associated with the element. The value may be quantitative, such as a measure (a shirt item may have a 32 sleeve length), or qualitative, such as a color (a shirt item may have a blue color) or an individual's preference for eco-friendly retailers.

In FIG. 1a, retailer 110a has attribute 112aa with an associated value 114aa and attribute 112ab with an associated value 114ab. Item 120a, which is in the inventory of retailer 110a, has attribute 122aa with an associated value 124aa and attribute 122ab with an associated value 124ab.

Further, retailer 110b has attribute 112ba with an associated value 114ba and attribute 112bb with an associated value 114bb. Item 120b, which is not in the inventory of retailers 110a, 110b, has attribute 122ba with an associated value 124ba and attribute 122bb with an associated value 124bb.

Customer 130a has attribute 132aa with an associated value 134aa and attribute 132ab with an associated value 134ab, and customer 130b has attribute 132ba with an associated value 134ba and attribute 132bb with an associated value 134bb

Examples of the elements in a commerce system 10a are shown in Table 1 as follows:

TABLE 1

| Element | | | |
|---|---|---|---|
| type | Element | Attribute | Value |
| Retailer | Macy's 110a | Type 112aa | Men's clothing 114aa |
| 110 | | Webpage | Yes 114ab |
| | | shopping 112ab | |
| | REI 110b | Type 112ba | Sporting goods 114ba |
| | | Location 112bb | 16 miles away 114bb |
| Item | Shirt 120a | Color 122aa | Blue 124aa |
| 120 | | Collar size 122ab | 16½ 124ab |
| | Bike 120b | Size 122ba | 15 124ba |
| | | Type 122bb | Mountain bike 124bb |
| Customer | Joe 130a | Gender 132aa | Male 134aa |
| 130 | | Neck 132ab | 16½ 134ab |
| | Mary 130b | Age 132ba | 27 134aa |
| | | Hobby 132bb | Biker 134bb |

FIG. 1b illustrates an exemplary computer-based commerce system 10b in accordance with one or more disclosed embodiments. In particular, system 10b may provide functionality for dynamic searching of elements of the commerce system. The system 10b has a personalized multi-dimensional avatar (PMDA) 136a, 136b associated with customer 130a, 130b, respectively, to be used to facilitate searching for goods or services or for other elements of the commerce system, using personalized criteria inputted by the customer or the retailer, which criteria may be modified and/or updated continuously to refine and update the search results until the desired goods are identified.

FIG. 1c illustrates an exemplary computer-based system 100 for use in implementing commerce system 10b in accordance with one or more disclosed embodiments. System 100 may include a retailer server 115, an item server 125, customer systems 135, 145, a content server 155, and optionally a smart phone 165. The retailer server 115, item server 125, customer systems 135,145, and content server 155 process and act upon instructions contained in code in software modules 113, 123, 133, 143, and 153, respectively.

Retailer server 115, item server 125, customer systems 135, 145, and content server 155 have portals 111, 121, 131, 141, and 151 respectively, through which they may be connected to each other directly or to each other indirectly via a network 160. One of skill in the art will appreciate that although one retailer server, one item server, two customer systems, one content server, and five portals are depicted in FIG. 1c, any number of these entities may be provided. Furthermore, one of ordinary skill in the art will recognize that functions provided by one or more entities of system 100 may be combined. For example, functionality provided by retail server 115 and item server 125 may be combined, and functionality provided by the portals may be combined or split apart.

Retail server 115, item server 125, computer systems 135, 145, content server 155, and smart phone 165 may directly or indirectly access data stores or other network applications (not shown) via network 160. Network 160 may be a shared, public, or private network. It may encompass a wide area or local area, and may be implemented through any suitable combination of wired and/or wireless communication networks. Furthermore, network 160 may comprise an intranet or the Internet.

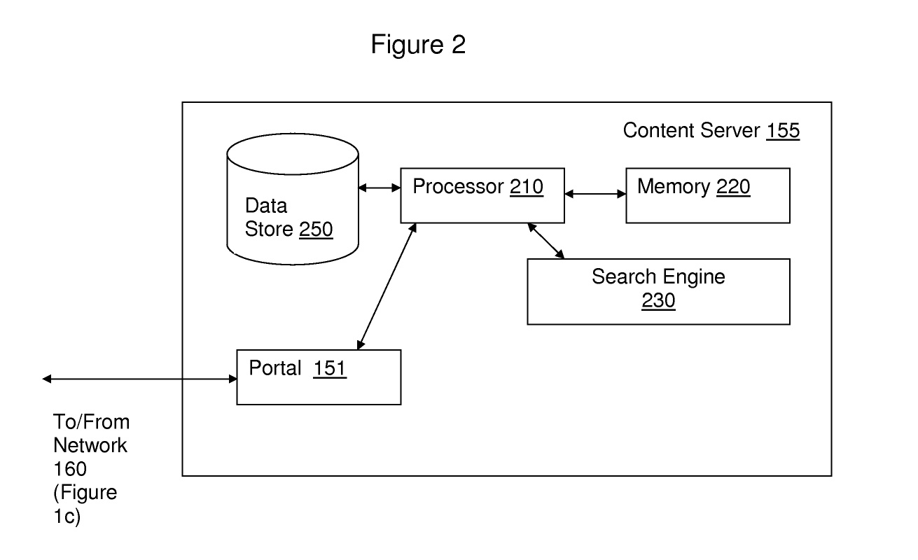

FIG. 2 illustrates an exemplary embodiment of content server 155, which may have a processor 210, a memory 220, a search engine 230, and a data store 250. Searches for suitable matches between elements of the computer-based commerce system are based on attributes and attribute values of the subject and target elements, and criteria input by the party desiring the search. Criteria may be attributes and associated attribute values for the subject element (such as a 28 inch waist), and desired attributes and attribute values for the target elements (such as a purple bead evening dress or an eco-friendly retailer). The search engine 230 may review the subject element's inputted data and compare them to the set of attributes and attribute values for the potential target elements. Data store 250 may store the search criteria received from, for, example, the retail server 115 or the customer system 135 for use by the search engine 230 in searching for compatible subject elements and target elements.

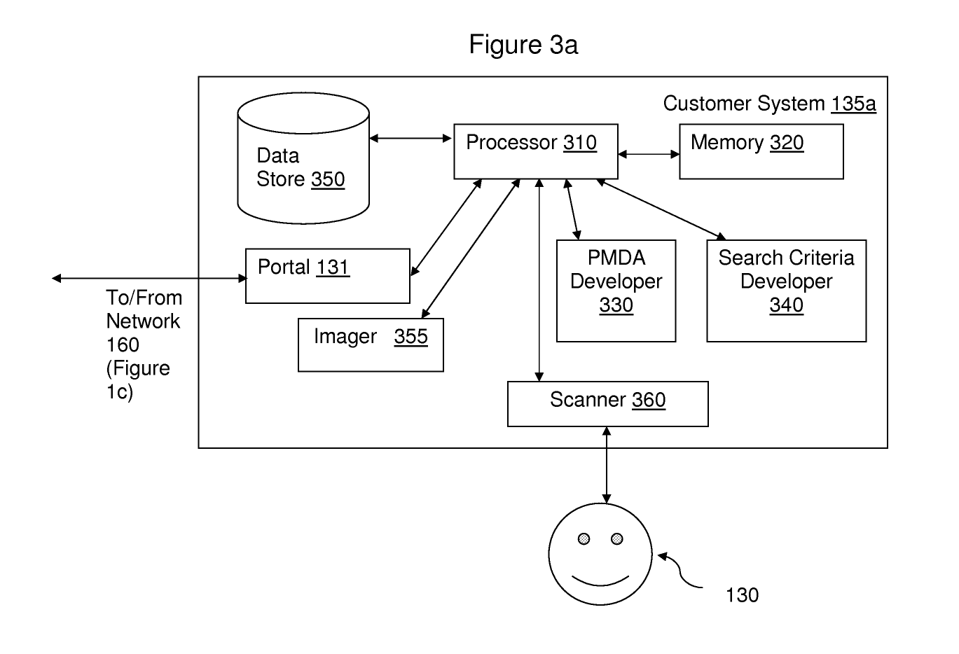

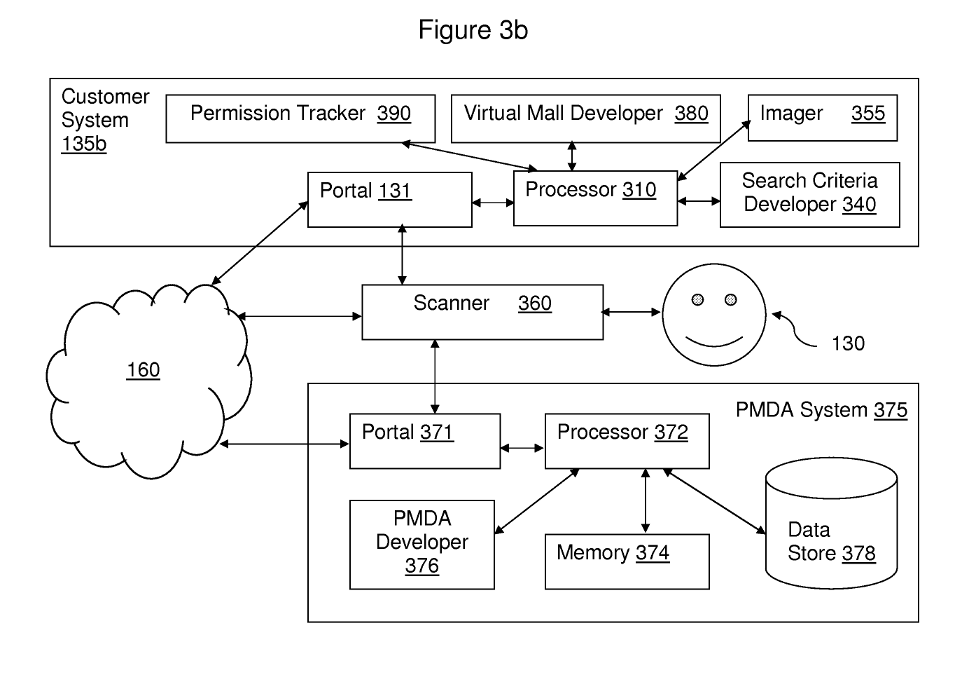

FIG. 3a illustrates an exemplary embodiment of a customer system 135a, which may be used for developing a PMDA. FIG. 3 is particularly illustrative of a customer system located at a kiosk in a mall. Customer system 135a may have a processor 310, a memory 320, a PMDA developer 330, a search criteria developer 340, a data store 350, a scanner 360, and an imager 355. The PMDA developer 330, which may be software instructions, may be used to develop a multi-dimensional personalized avatar representing the customer 130 for use by the search engine in conducting searches for compatible elements in a commerce system. The PMDA may include data related to attributes of the individual and their associated attribute values. The search criteria developer 340, which may also be software instructions, may be used to develop criteria to be used by the search engine in conducting searches for compatible elements of the commerce system.

The data store 350 may store data describing the PMDA and search criteria. It may also store permissioning preferences of the customer for controlling access to the customer. For example, the permissioning preferences may include preferences of the customer as to the type of access to the PMDA that are allowed to the search engine. Alternatively, the permissioning preferences may include preferences of the customer as to the type of contact with the represented individual allowed to parties. For example, the permissioning preferences may authorize parties to contact the customer directly to offer items for sale, and it may include preferred methods and times of the permitted contacts. The permissioning preferences may restrict selected parties from contacting the customer, or it may authorize release of general non-identifying information about the customer for general or specific purposes, such as for use in tailoring product lines for customers or in developing marketing or sales strategies. The data store 350 may store the permissioning preferences separately or as part of the PMDA.

The scanner 360, which may be any conventional scanning mechanism, may be used to scan and take measurements of an individual 130 for inputting as data to the PMDA developer 330. Alternatively, the individual may be manually measured and the measurements input into the developer 330 using any known I/O device (not shown). The imager 355 may be used to display a simulation of how an item in the commerce system would operate with an individual in the commerce system. One of skill in the art will appreciate that although this embodiment depicts the imager as a part of the customer system, it may be provided in the retailer server, the item server, multiple customer systems, and/or the content server.

FIG. 3b illustrates another exemplary embodiment of a customer system 135b, in which the customer system, scanner, and PDMA developer are separate components. PMDA system 370, which may be implemented as a web site accessible via network 160, may have a portal 371, a processor 372, a memory 374, a PMDA developer 376, a data store 378 to store data describing the PMDA, a virtual mall developer 380, and a permission tracker 390. Scanner 360 and PDMA system 370 may be connected to each other directly or to each other indirectly via the network 160. The permission tracker 390 may be used to receive permissioning preferences of the represented individual for contact of the represented individual or for use of the specifications for the PMDA for the represented individual. The permission tracker 390 may be used for allowing contact of the represented individual and use of the specifications for the PMDA based on the permissioning preferences. As with system 135a, permissioning preferences of the customer may be stored in any convenient location and a conventional I/O device may be substituted for the scanner 360.

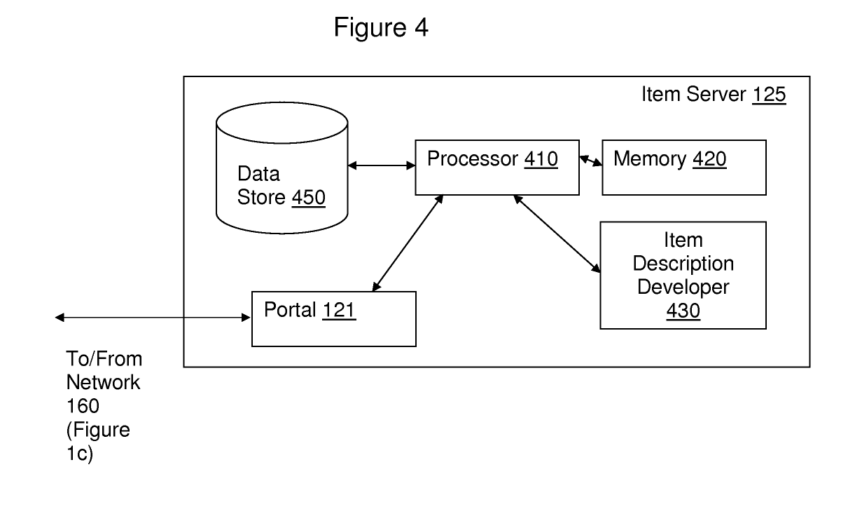

FIG. 4 illustrates an exemplary embodiment of item server 125, which may have a processor 410, a memory 420, an item description developer 430, and a data store 450. The item description developer 430, which may be software instructions, may be used to develop descriptions of the items for use by the search engine in conducting searches for compatible elements of a commerce system. The descriptions may include data related to attributes of the goods and services and their associated attribute values. The data store 450 may store data describing products and/or services offered for sale. For example, data store 450 may store web sites or web pages that are displayable by a computer executing software, such as an Internet browser for providing information about the items and the sources from which the items may be obtained. Furthermore, data store 450 may store product or service descriptions, prices, and media used in connection with the sale of the products and/or services. Products and/or services having information stored in data store 450 may be associated with a unique product type or item type identifier (ID), for example.

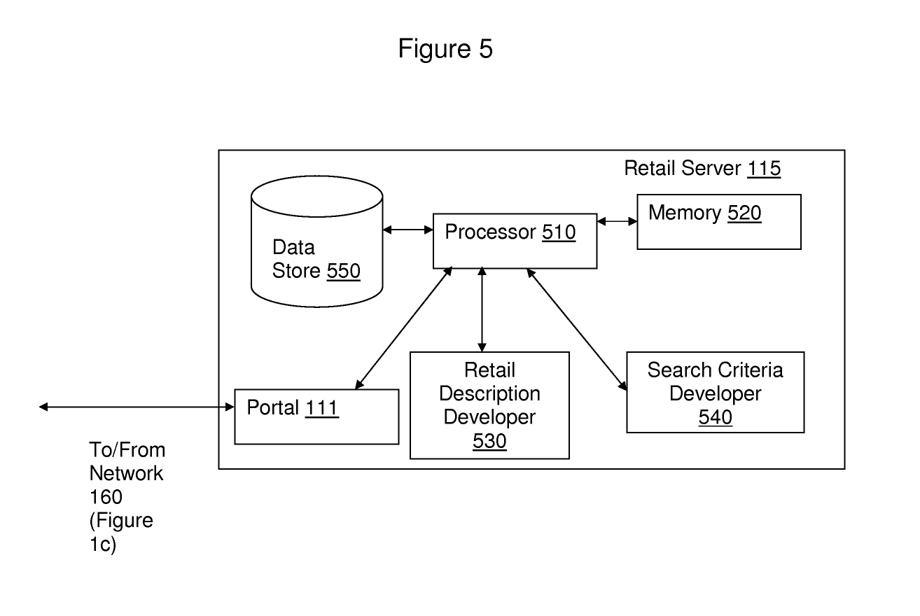

FIG. 5 illustrates an exemplary embodiment of retail server 115, which may have a processor 510, a memory 520, a retail description developer 530, a search criteria developer 540, and a data store 550. The retail description developer 530, which may be software instructions, may be used to develop descriptions of the retailer for use by the search engine in conducting searches for compatible elements of the commerce system 10b. The descriptions may include data related to attributes of the retailer and their associated attribute values. The search criteria developer 540, which may be software instructions, may be used to develop the criteria to be used by the search engine in conducting searches for compatible elements of the commerce system 10b. The data store 550 may store data describing the subject retailer. It may store web sites or web pages that are displayable by a computer executing software, such as an Internet browser for providing information about the retailer and the items that are available through the retailer. The data store 550 may also include links to data about the goods and services that are available through the retailer.

The memories 220, 320, 374, 420, 520 may be one or more memory or storage devices that store data as well as software. They may also comprise one or more of RAM, ROM, magnetic storage, or optical storage, for example. They may store program modules that, when executed by the processors 210, 310, 372, 410, 510, perform the processes discussed above. Program modules that provide the development, maintenance, and use of the avatars, retail and item descriptions, and search criteria, and that conduct the searches and identify the target elements are discussed in more detail below in connection with FIGS. 1a-1c, and 2-5.

One of skill in the art will appreciate that one or more of the components depicted in FIGS. 1a-5 may be implemented in software on one or more computing systems. For example, they may comprise one or more applications, which may comprise one or more computer units of computer-readable instructions which, when executed by a processor, cause a computer to perform steps of a method. Computer-readable instructions may be stored on a computer-readable medium, such as a memory or disk. Such media typically provide non-transitory storage. Alternatively, one or more of the components depicted in FIGS. 1a-5 may be hardware components or combinations of hardware and software such as, for example, special purpose computers or general purpose computers. The servers 115, 125, 155, and systems 135, 145 may be a single processor, a series of processors within a single computer, a series of computers in mutual communication containing one or more processors, etc. They may be any type of computers or computer systems, which may be implemented in various ways. Computers or computer systems, for example, may comprise one or more processors, memory, an input/output (I/O) devices, nonvolatile storage devices, etc. A computer or computer system may also comprise an internal or external database. The components of a computer or computer system may connect through a local bus interface.

They may also be implemented in a distributed network. For example, they may communicate via network 160 with one or more additional servers or systems (not shown), which may enable a server or computer system to distribute processes for parallel execution by a plurality of retail servers.

### Operation

Imagine a world where you can shop electronically (e.g., on-line) for any product or service using your PMDA to define and improve your shopping experience. By merely clicking on a compatible web site with your PMDA, you may be presented with all the available products on that web site that may accommodate or are otherwise may be compatible with your PMDA (i.e., meeting the inputted criteria for your PMDA). You may even be advised what styles and products work best with your PMDA, and what styles and the like to avoid.

The PMDA is a computer based system that may greatly benefit, among others, both customers and retailers in many different and profound ways. One embodiment of the present invention concerns the personalized multi-dimensional PMDA that an individual (customer) creates to mirror their or, in some cases, another person's or even an animal's own personal dimensions or measurements (and other personal traits and/or preferences if desired or necessary).

In one embodiment, an individual may go to an on-line, computer based system, such as a web-based site, and create a PMDA (male, female, teen, child, infant, animal, etc.). When that individual first logs onto or enters the avatar web site, the individual may be greeted by a blank avatar figure, and asked to create a PMDA. Based on a series of prompts, input fields or other input queries from the web site, the customer may enter the individual's personal body measurements, such as head size, neck size, shoulder width, chest and/or breast size/type, waste size, hip size, arm and leg (inseam, etc) size, biceps size, thigh size, forearm size, calf size, and feet and hand size/dimensions. It is within the scope of this invention and embodiments described herein that multiple measurements may be needed for a particular body part (e.g., head, thigh, bicep, forearm breasts, hand dimensions such as finger lengths etc.) and/or desirable to accurately create the PMDA. The amount and extent of the information may depend entirely on the intended end use of the PMDA. For example, if the customer is only interested in buying gloves, he may need to enter only information pertinent to his hands. In addition, and in another embodiment, the PMDA may be updated and modified anytime, and in another embodiment may be password protected for privacy.

After providing the necessary information, the PMDA may be generated and may reflect the inputted measurements, dimensions and other personal traits inputted or entered into the system. For example, in yet another embodiment, and in addition to body measurements, the creator may further modify the PMDA to take on other traits or characteristics, such as hair and eye color, hair style and length, and even specific facial features. Ideally, although not required for all applications, the PMDA is a three dimensional person or animal. It is anticipated, however, that other applications may only require two dimensional or other multiple dimensional objects.

The PMDA may be password protected for privacy, to prevent third parties from intentionally or inadvertently altering the PMDA, and/or to prevent any interaction between the PMDA and another third party web site or PMDA without permission. It is envisioned that a customer may be able to update his PMDA as frequently as he likes, either before, during or after searching for goods from compatible web based retail systems. For example, as sizes, styles, personal traits, and the like change over time, the customer may wish to update his PMDA. In addition, while actively searching for goods that meet his PMDA's criteria, he may decide/need to further limit the number of hits received by further narrowing desired search criteria.

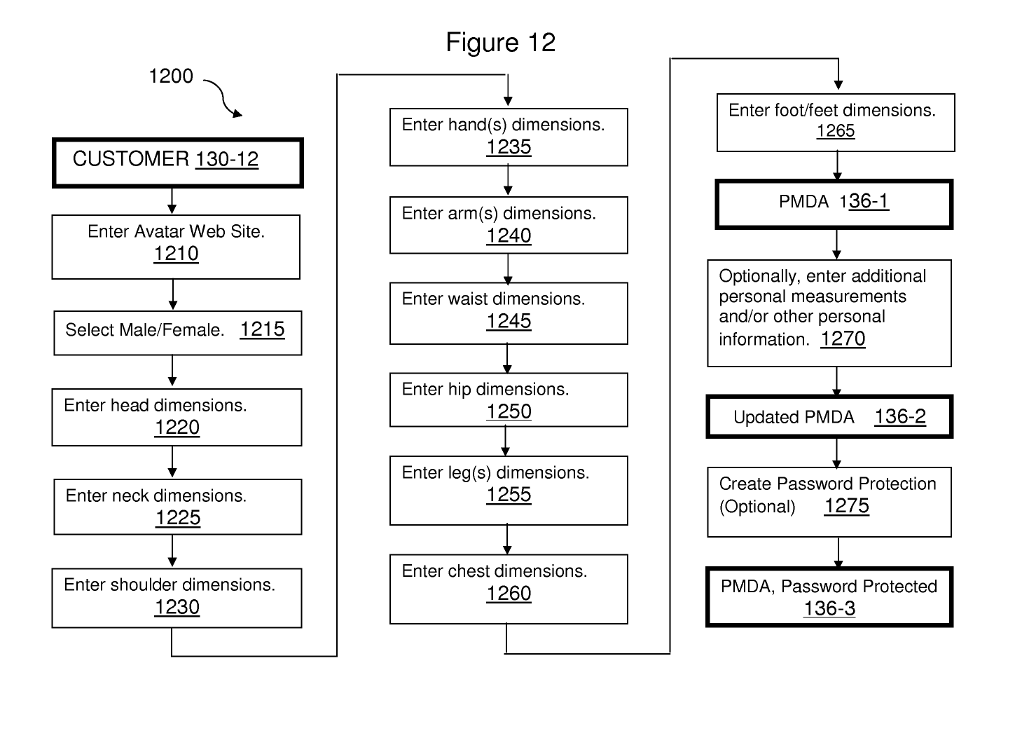

FIG. 12 shows an exemplary embodiment of a customer creating his/her PMDA. The customer enters an avatar web site (stage 1210), is asked to select a gender (stage 1215), and then is prompted through a series of inquiries regarding measurements for various body part dimensions (stages 1220-1265). Upon completion, a personalized avatar 136-1 is created. As shown, at any time, the PMDA 136-1 may be updated to become PMDA 136-2 with more body measurements and/or to reflect other personal traits and/or preferences/styles, etc. (stage 1270). Further, the PMDA, optionally, may be password protected (stage 1275) to become PMDA 136-3.

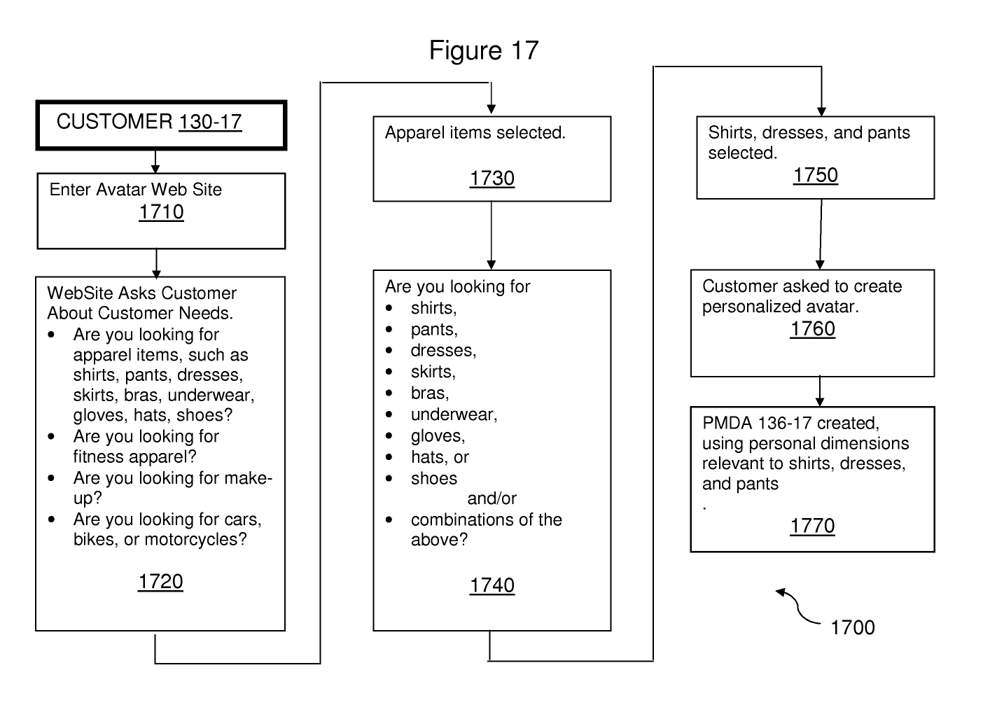

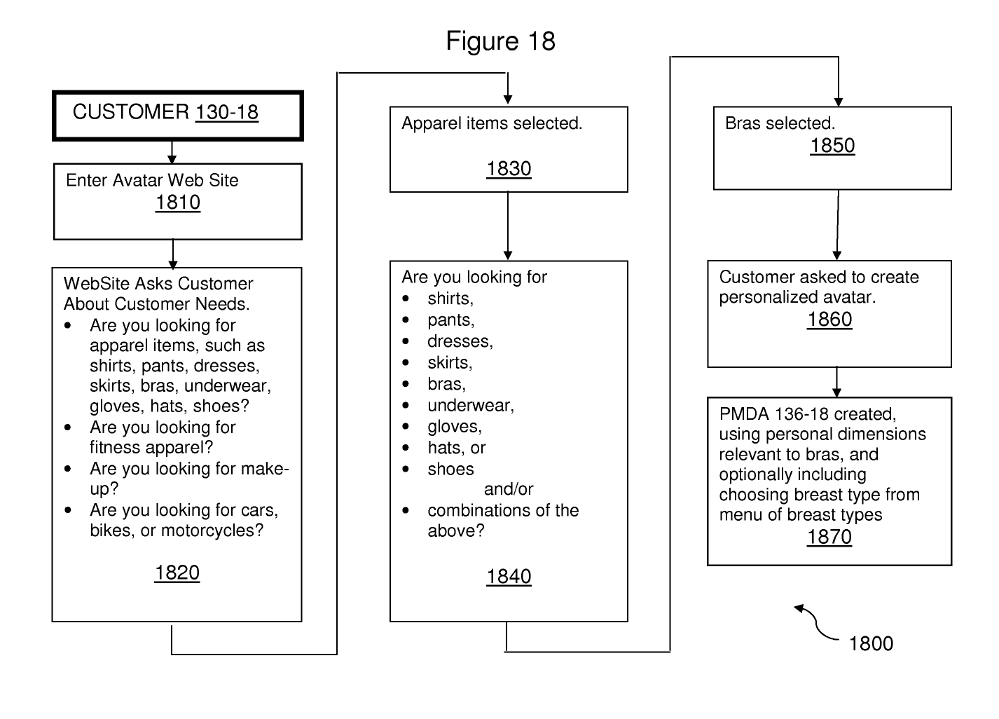

FIGS. 17 and 18 illustrate how more specialized PMDAs may be created depending on what the customer is interested in purchasing. In the process 1700 show in FIG. 17, a customer 130-17 may access a PMDA developer (stage 1710). The PMDA developer may be at an avatar web site or it may be at a kiosk at a shopping location such as a mall kiosk. Alternatively the kiosk site may access a PMDA developer website. The PMDA developer may be interactive and allows input about the customer needs. The developer may be field-driven or allow for answers to be open ended. It may allow for a person's measurements to be manually input or it may allow for data from a scanner to be input for use in developing the PMDA.

For example, the customer may be asked to identify the type of items of interest, such as apparel items, fitness equipment, make-up, or transportation items (cars, bikes, or motorcycles) (stage 1720). The customer may select apparel as the items of interest (stage 1730). The developer may then inquire deeper about the type of apparel items, for example asking the customer to identify the type of apparel, such as shirts, pants, dresses, skirts, bras, underwear, gloves, hats, or shoes, and/or combinations of the above (stage 1740). The customer may select, for example, shirts, dresses, and pants (stage 1750). The customer may be asked to create a personalized avatar (stage 1760). The PMDA 136-17 may be created, using the customer's personal dimensions relevant to shirts, dresses, and pants (stage 1770).

In the process 1800 shown in FIG. 18, the illustrative PMDA developer is also an avatar web site. The customer enters the avatar website (stage 1810). The PMDA developer asks for the type of items of interest (stage 1820) and receives the answer that apparel items are desired (stage 1830). Upon deeper inquiry about the type of apparel (stage 1840), the customer may select, for example, bras (stage 1850). The customer may be asked to create a personalized avatar for bra shopping (stage 1860). The PMDA 136-17 may be created, using the customer's personal dimensions relevant to bras (stage 1870). Optionally the customer may choose breast type from a menu of breast types.

As an alternative to measuring and entering personal body measurements manually, it is envisioned that computer scanning devices capable of measuring and determining personal body dimensions may be used to create a PMDA. The scanner may be used to directly input a customer's personal body measurements to the PMDA web site by, for example, a USB cable or wireless transmission device, or stored on a memory device for later use in uploading the scanning data to the PMDA web site. In one embodiment involving a scanning device, a kiosk at a mall is equipped with a scanner(s) and is linked to a PMDA web site that will enable a customer to create a PMDA while at the mall. In addition, while at the kiosk, the PMDA may be updated manually with other personal information and/or preferences. In another embodiment, the kiosk created PMDA may be accessed by the customer anytime and anywhere via computer, and updated with more scanner derived taken data or other manually obtained data or other personal information and/or preferences.

In another embodiment, once created, the PMDA may be later accessed from anywhere in the world having computer access to the PMDA web site. For example, a customer may be traveling overseas and access her PMDA to do some shopping while overseas. In another embodiment, her PMDA may automatically update its dimension data to correspond to whatever unit of measurement is applicable in the particular country in which the retail site or system is located. For example, data may be initially inputted using the U.S. system of measurement, and may be converted to the metric system used in many other parts of the world when the PMDA is searching in those systems, or the Chinese unit of measurement when searching in Chinese-based systems.

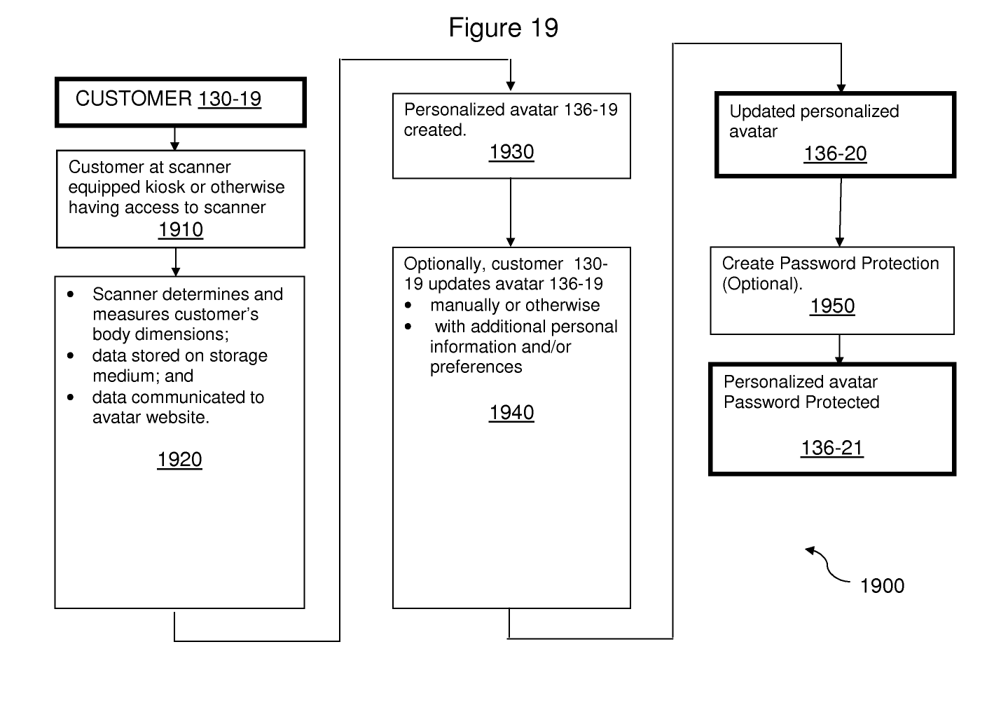

FIG. 19, described below, illustrates an embodiment how a customer may create a PMDA using at least some scanning technology.

In another embodiment, a blank avatar may appear when a customer first visits or log onto a retailer's web site for the first time, and she may be asked to create a PMDA according to specific input queries/fields. The retailer may require the customer to create its PMDA as part of the customer's visit to the retail web site.

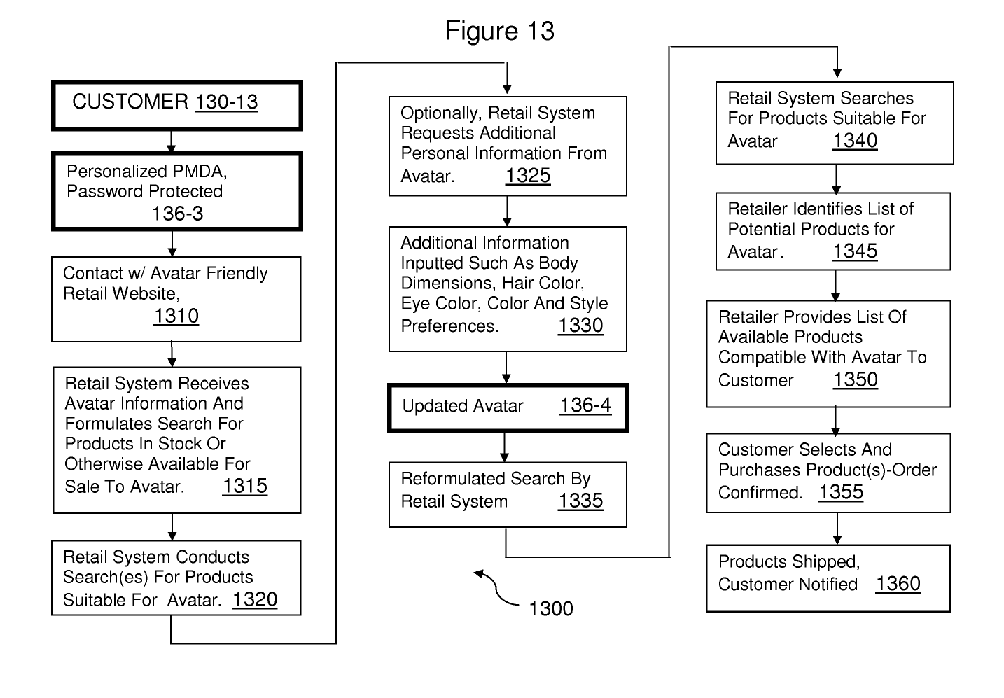

FIG. 13 shows an exemplary embodiment of a customer created PMDA 136-3 communicating with a retailer web site to search for and purchase goods. The PMDA is used to make contact with a retail web site that is PMDA compatible (stage 1310). After contact is established between the PMDA and at least one retail site, the retail site may conduct a search of its inventory and/or product offerings to determine what products are compatible with, may likely work with or might fit the PMDA (if, for example, clothes are the goods sought) (stage 1315, 1320). Optionally, the web site may ask for more information such as additional body measurements and/or likes and preferences to further refine and/or narrow the search results (stages 1325, 1330, 1340). The PMDA may be updated with the additional information to form updated PMDA 136-4. The retailer may identify a list of potential products (those that are compatible with the PMDA) for the PMDA (stage 1345). In addition, the list may include only those products that are currently available. The results of the search (or the optionally updates search) may then be conveyed to the PMDA (customer) for review (stage 1350). PMDA (customer) may then select any products he/she likes and make the purchases (stage 1355), which then may be shipped to the customer (stage 1360).

In one embodiment, the PMDA may be used to search retail sites for products that may fit the avatar's dimensions and satisfy other personal criteria. For example, if the PMDA's creator likes clothes and/or accessories that contain white and that may accommodate his personal PMDA's dimensions, his PMDA may be configured to interact or communicate with at least one retail web site to identify all items available or in stock that at least contain some white and that accommodate his PMDA's size and shape (i.e., that accommodate his size and shape). In another embodiment, a PMDA or the retail web site may prompt the individual for more information (i.e., more personal dimensions or other personal information) to further limit search results or to change or update input criteria to help further refine the search and potential selections.

In another embodiment, customer's PMDAs may be stored on a retailer's data store. If a prospective customer contacts a retailer with her PMDA and she had previously created a PMDA during an earlier search or through another activity directly with the retailer, the prospective customer may be prompted to update her retailer PMDA with more current information or to provide her current PMDA. Alternatively, the customer may be prompted to indicate whether or not she had a more current PMDA or if she wished to update the PMDA stored at the retailer's data store.

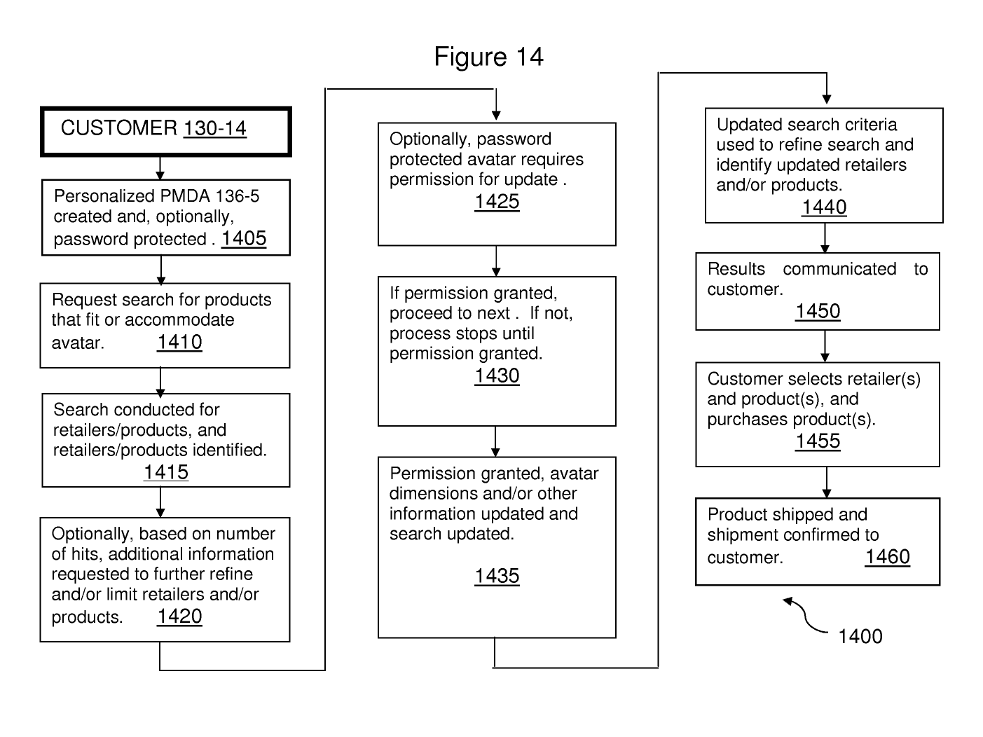

FIG. 14 shows an exemplary embodiment in which a PMDA is used to search for retailers that carry goods and products of a type sought by the customer that may accommodate, be suitable for, fit or otherwise be appropriate for the PMDA, based on the inputted criteria. After the PMDA 136-5 is created and optionally password protected (stage 1405), the customer may be able to formulate/request a search for a particular item (such as clothes) that may be meet the PMDA's criteria (stage 1410). For example, the PMDA may be used to specify size, color, and style preferences for shirts, pants, dresses, sweaters, gloves, shoes, etc., and the PMDA may be used to search for any and all retailers that sell or provide these products. Once the search criteria are chosen and inputted, the PMDA may be used to initiate a search and locate the retailers that have the desired products, or simply locate all such products that meet the criteria (stage 1415). Once the retailers are located, the PMDA may interact independently with each retailer, much like that described and shown in FIG. 13. Optionally, a specific retailer(s) may prompt the PMDA to be updated with more information/criteria to further refine the search results (stage 1420). Optionally, as shown in FIG. 14, the PMDA may give permission to be contacted by a specific retailer after the initial search is conducted by the PMDA, or to be further contacted by the retailer if other items later become available (stages 1425, 1435, 1440). If permission is not granted, the process may be stopped until permission is granted (stage 1430). The results may then be communicated to the PMDA (customer) (stage 1450) and the customer may then purchase any products desired (stage 1455), which products may then be shipped (stage 1460).

In another embodiment, for example, where clothes are the product being sought for purchase by the customer (PMDA), the customer may have the option to use an imager, such as imager, 355, to display a simulation of how the clothes item may fit the customer. The imager may display the clothes juxtaposed on the PMDA. The imager may present images in which the PMDA try on selected clothes so the customer may see how they appear on the customer in real life. In this embodiment, the individual has the ability to see how the clothes appear on them from multiple angles and even under different conditions. For example, a men's long sleeve shirt may be viewed on the PMDA with the arms at it side, out in front and over head to determine the shirt's fit on the customer if purchased. In another embodiment, the PMDA may communicate how well the item of clothing fits (e.g, too tight, too loose, or about right, taking into account any personal preferences expressed by the avatar). In another embodiment, shading or some other means may be used to show areas of tightness and/or looseness or address other issues that might be relevant to a buyer. In yet another embodiment, the clothing may be made to appear translucent, so the potential buyer may see his PMDA's figure under the clothing to see how well the article of clothing fits. It is envisioned that clicking and dragging or other equivalent or new means may be used to put the clothing on the PMDA. Alternatively, a prospective customer may be prompted by the web site as to whether she wants to try on the selected or identified clothing.

Such a system described above may reduce the frustration of shopping on-line, reduce costs and hassles associated with items that don't fit and the necessary returns of product and subsequent re-ordering needed.

In another embodiment, for example, the customer wants to look for bikes and decides to visit a bicycle (or motorcycle) web site (or search for all products or retailers that meet the inputted criteria). The customer conducts an Internet search with her PMDA, and all the bikes available or in stock that may fit the PMDA's specifications and the customer's search criteria may be presented for her consideration and proper fitting. For example, certain people with really long legs or torsos may be best suited by a particular brand and size of bike. The PMDA may help discover the best options for the long-legged customer. She may be further prompted to refine or narrow her search by inputting color and model preferences. In another embodiment, the PMDA may be placed on the bike or motorcycle so that the customer may see how she would fit and look on the bicycle. And, like the clothes example above, the web site may be programmed to provide feedback on how well that particular bike fits the customer's PMDA.

In all embodiments of the invention described herein, there may be repeated back and forth communications between the web site and customer (PMDA) until the customer gets exactly what she wants, namely that which matches her PMDA's dimensions and preferences.

In another embodiment, after a customer has created her PMDA, she may choose to search for only those stores or web sites that sell items or retailers of other item sources with specifications that are compatible with the customer's PMDA. For example, a plus size woman may elect to only search for plus size items and sources and retailer that specialize in items for plus size women, such as plus size workout clothing or plus size evening ware, formal ware, etc. The PMDA may be used to search for the web sites that provide the best options for the PMDA, whether they are specialized stores or stores that simply carry products of the type being sought.

For example, clothes for tall men and women, muscle builders, short people, and people with special needs may be notoriously hard to find and buy on-line. A PMDA may greatly enhance the possibilities of successfully finding clothes that fit and simultaneously limit wasted time and energy.

In another embodiment, many women complain that buying bras (that fit!) is one of the most challenging experiences for them today on the internet because a customer doesn't know if the bra will fit until she tries it on. Thus, in another embodiment, a PMDA is designed especially for finding the best fitting bra. FIG. 19 is a flowchart depicting a process 1900 for creating a personalized avatar by use of a scanner(s) and, optionally, manual data entry. A customer 130-19 visits a scanner equipped kiosk or otherwise has access to a scanner to develop an avatar for bra shopping. The customer may develop an avatar for specialized bra shopping, or she may develop a whole body avatar for all purpose shopping and use only the relevant portion for the shopping trip (stage 1910). The scanner determines and measures the customer's body dimensions. The data may be stored on storage medium, and the data may be communicated to an avatar website (stage 1920). A PMDA 136-19 is created (stage 1930). Alternatively, the PMDA developer may be available at the kiosk, and the PMDA created at the kiosk. Optionally, the customer 130-19 may update the avatar 136-19, manually or otherwise, with additional personal information and/or preferences to create updated PMDA 136-20 (stage 1940). The customer may assign a password to the PMDA (stage 1950) to form a password protected PMDA 136-21.

Although manual measurement and data input may be used, it is envisioned that scanning technology may be the best and most accurate method to create a PMDA for searching for bras. It is believed that scanning may be the best method to capture a female's exact breast dimensions and type (e.g., shape). As is the case with all PMDAs envisioned herein, additional criteria such as color, styles, etc may be associated with the PMDA before, during, or after a search is initiated to find the best bra.

Similarly, specialized PMDAs may be created to buy gloves, shoes, hats, or pretty much anything that requires more detailed measurements, so called specialty items. By way of example only, if interested in searching for and buying gloves, finger/thumb length and finger/thumb thicknesses are important determinants in the glove fitting calculus, and measurements of those parameters may be used to create a glove PMDA to assist in searching for the perfect fitting glove.

In yet another embodiment, a retailer may be interested in searching for all PMDAs that represent individuals who may be potential customers for its products. Based on the retailer's product line(s) and inventory, it may input search criteria into a search engine capable of searching for all PMDAs meeting some or all of those criteria (i.e., having at least one overlapping criteria). Thus, the retailer may potentially identify new customers or even those who have been past customers and alert them to new products and the like.

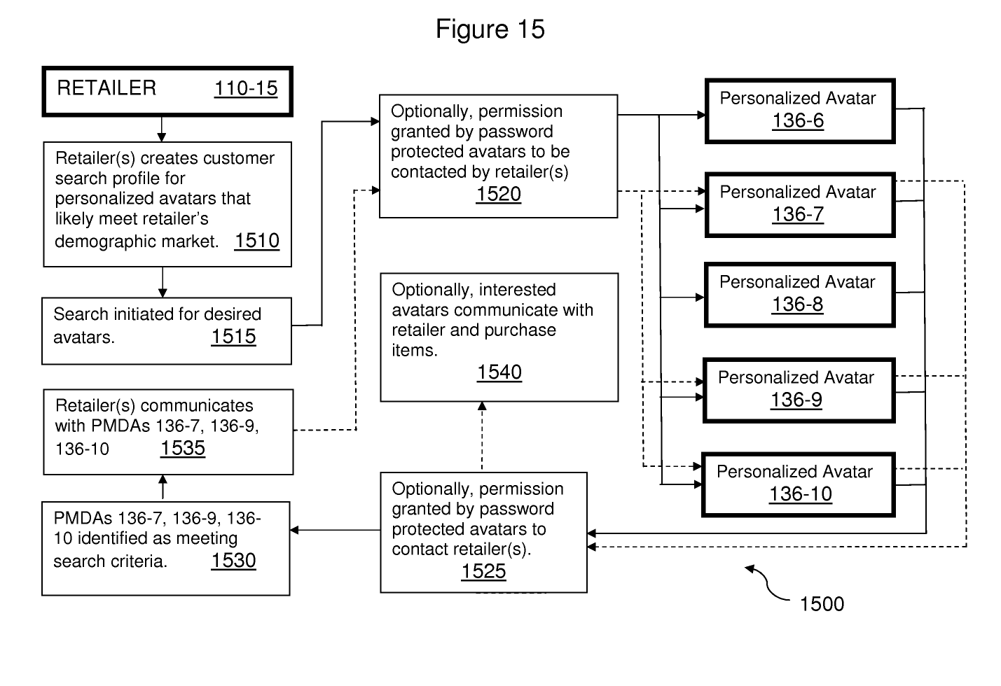

FIG. 15 shows an exemplary embodiment where a retailer 110-15 searches for PMDAs that represent individuals who may potentially be interested in its product line(s)-based on demographics or past shopping history. A retailer(s) may conduct search for PMDAs for individuals who are likely to be interested in its product(s) by age, style, body types, body dimensions and/or other criteria (stage 1515). Upon initiating a search, the retailer may identify certain PMDAs representing individuals who are candidates to be contacted (stage 1530), and then the retailer may initiate contact with those PMDAs identified (stage 1535). Optionally, based on the permissioning preferences, the PMDAs may first have to give permission for the initial contact (stage 1520) or subsequent contact (stage 1525), and then may be contacted or further contacted by the retailer once permission is granted (stage 1535). Those permissioning preferences that give permission may then be able to communicate with the retailer and, optionally, choose to purchase product(s) (stage 1540).

In another embodiment, the retailer's or seller's experience may also benefit greatly from the PMDA system and technology. Not only does the PMDA help reduce returns (and therefore costs) by cutting down on incorrectly sized/fitted product (e.g., clothing) being ordered and returned, and provide potential sources of new business for retailers, even identifying past customers who previously bought product from the retailer, the PMDA offers immense opportunities for the retailer to collect very specific demographic data (“data mining”) about its customer base, including sizes and other personal preferences. This data may be used by the retailer to focus its brands on its customer base and even develop new products lines tailored towards its primary customer base, or otherwise expand its customer base. The retailer may use this data to design new clothes and styles and/or to stock more items for a specific demographic group that represents a majority of its customer base.

In another embodiment, the PMDA may be programmed so that its creator first gives permission for a retailer to retain and use the personal PMDA data in a data base. Thus, due to the permissioning preferences associated with the customers, the customer is ultimately in control of its personal data, and may have to first authorize its collection and use by a retailer, and even under what circumstances the data may be used. Alternatively, a retailer may deny access to the PMDA unless its owner agrees to let the retailer use such information for its own business purposes, and provided, for example, it is kept confidential by the retailer.

In yet another embodiment, the PMDA web site or a web site linked with the PMDA may provide a customer with desirable feedback after the avatar is created, such as the body type, styles of clothes that may look best on the customer's body, and even suggestions to help the customer obtain a different body type by, for example, exercise and/or diet suggestions—so called recommend engines. Such a response may include links to appropriate sites.

In another embodiment, the PMDA or web site linked to the PMDA may be used for progress reports on exercise or diet plans (based on updated PMDA criteria, such as body size and dimensions). Alternatively, the PMDA or web site linked to the PMDA may be allowed to link with a third party web site that provides fitness and dietary information.

In another embodiment, the PMDAs may be used to find other similar avatars, e.g., similar shapes, sizes, personal preferences, so that PMDA's creators may share information about products they like and dislike, etc. Similar PMDAs may be used as tools to find compatible persons, i.e. those individuals who might date or share similar interests with.

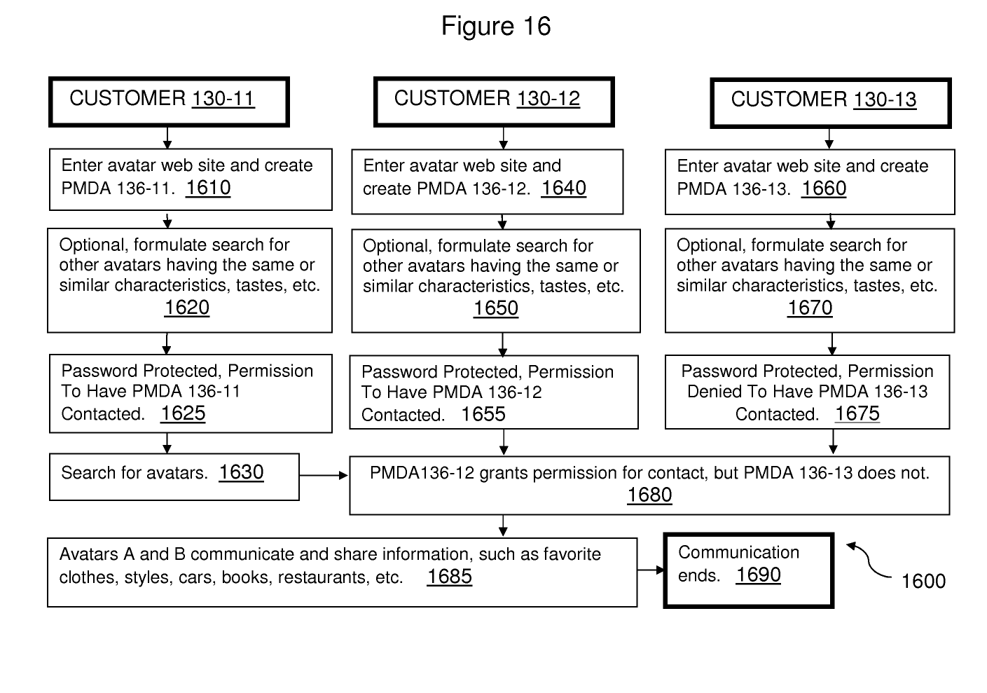

FIG. 16 shows an embodiment where PMDAs may search and communicate with each other, based on their similarities and/or differences. Individual PMDAs may formulate searches for other PMDAs based on similar criteria (i.e., similar in age, size, personal preferences, etc, or very different) (stages 1620, 1650, 1650). In FIG. 16, for example, Customer 130-11 creates his/her PMDA (stage 1610) and formulates searches for other PMDAs having the same or similar criteria (stage 1620). As with all cases, the PMDAs may be password protected to insure privacy and to avoid being contacted or solicited by retailers, advertisers, or other PMDAs (stage 1625). Customers 130-12, 130-13 may also create PMDAs (stage 1640, 1660) and formulate searches for other PMDAs having the same or similar criteria (stage 1650, 1670). As with all cases, the PMDAs may also be password protected (stage 1655, 1675). In FIG. 16, Customer 130-11's PMDA contacts or attempts to contact PMDAs of Customers 130-12, 130-13. Customer 130-12's PMDA agrees to be contacted while Customer 130-13's PMDA does not (stage 1680). Customer 130-11's PMDA and Customer 130-12's PMDA then communicate with each other and share information (stage 1685).

In another embodiment, a PMDA application may be developed for smart phones such as the iPhone™ system. For example, the PMDA application may notify the customer on a smart phone such as smart phone 165 when he or she is near a store that sells goods of the type th at meet the customer's PMDA's criteria (assuming the iPhone PMDA is actively searching and not turned off).

In another embodiment, the PMDA may be used to find sources providing customized and other specialty bras, and then used to create custom tailor and designed bras.

In another embodiment, the customer may create a virtual mall on their web site page, for example, using the virtual mall developer 380, by clicking and dragging selected retailers and products and/or sources of products identified by conducting searches described above to a virtual mall space on their web site. The virtual mall created by the customer may contain their favorite retailers, products, or other links for easy subsequent searching. For example, the customer may want to quickly search their favorite retailer to see what new products exist that might meet their PMDA criteria. The virtual mall may be a quick way to allow the customers when they first log onto their web page to go directly to sources they already know and like to search for familiar and/or new products. In another embodiment, the virtual mall may be programmed to notify the customer anytime a new product meeting their criteria and originating from a source identified in the virtual mall was identified. Essentially, the virtual mall may be programmed as a 24/7 watch for new products that meet virtual mall criteria, and notify a customer anytime something new is identified.

The possibilities for your PMDA are endless. For example, your PMDA may be used to search for and/or buy special made tailored clothes such as suits, dresses and wedding gowns. In addition, it is anticipated that there are uses for cars, shoes, gloves, hats, infants, maternity clothes, fitness, health, style, make-up, children, teenagers, and on and on.

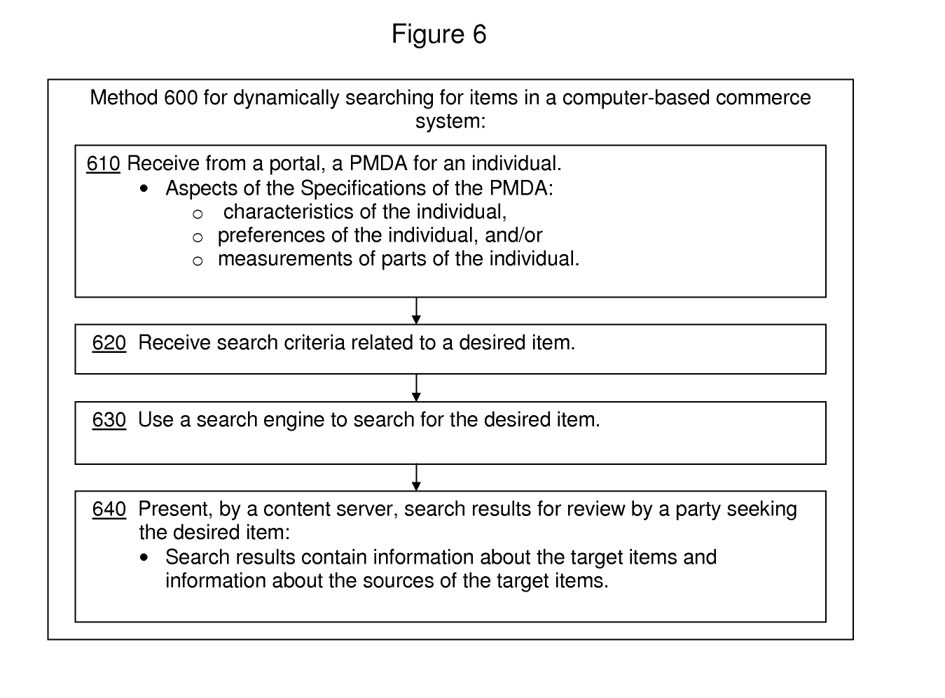

FIG. 6 shows an exemplary embodiment of a process 600 for dynamically searching for items in a computer based commerce system according to one exemplary embodiment. In the process 600, a PMDA for an individual may be received by a processor (stage 610). Aspects of a PMDA's specifications may include characteristics of the individual, preferences of the individual, and/or measurements of parts of the individual. Search criteria related to a desired element also may be received from a portal (stage 620). A search engine may be used to search for the desired element (stage 630). The search results may be presented by a content server to a party seeking the desired element. Search results may contain information about the target items and information about the sources of the target items.

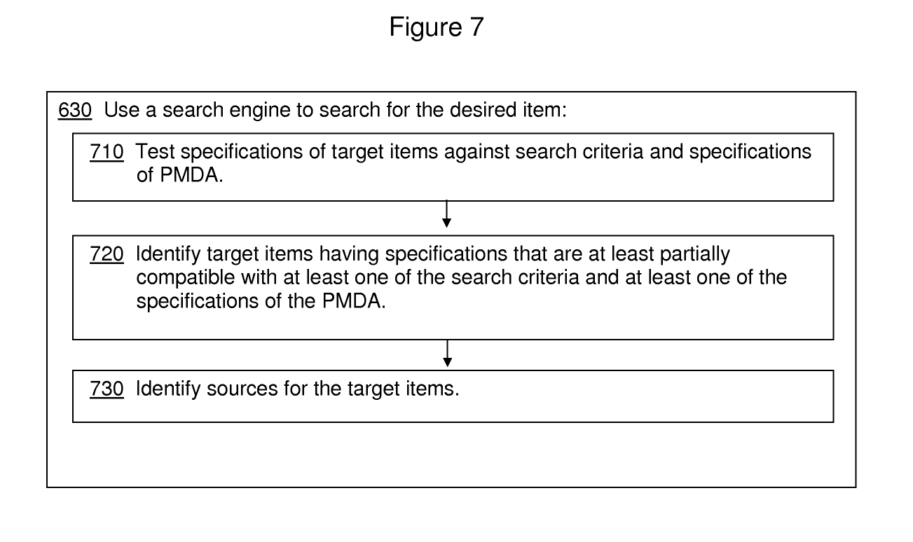

FIG. 7 is a flowchart depicting one embodiment of the stage 630 for using a search engine to search for the desired item. The specifications of target elements may be tested against search criteria and specifications of the PMDA (stage 710). Target items having specifications that are at least partially compatible with at least one of the search criteria and at least one of the specifications of the PMDA are identified (stage 720). Sources for the target items may also be identified (stage 730).

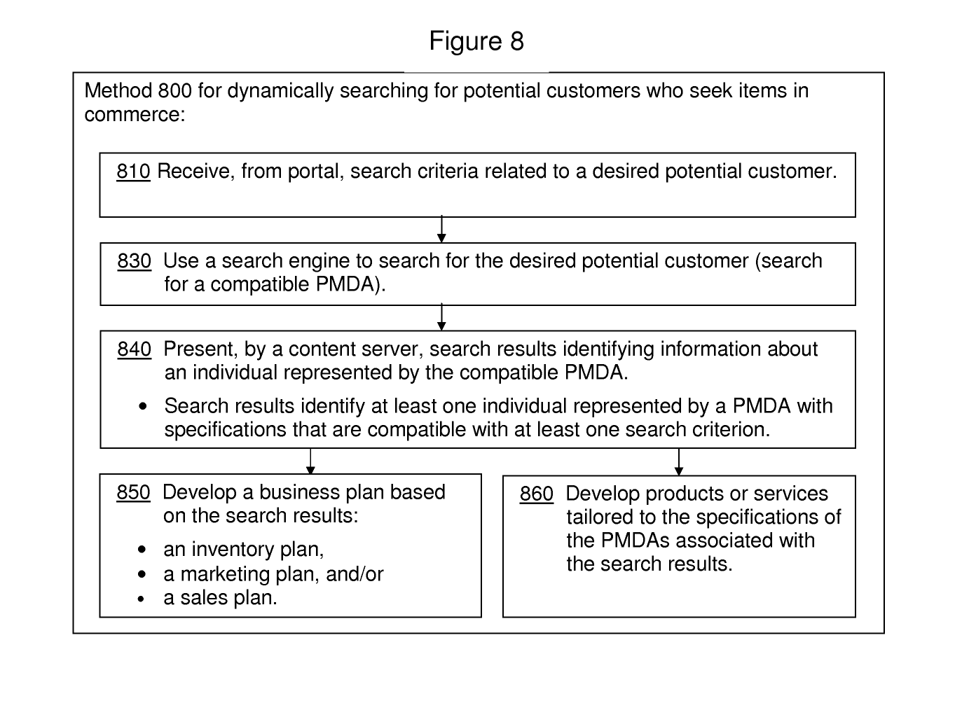

FIG. 8 shows an exemplary embodiment of a process 800 for dynamically searching for potential customers in a computer based commerce system according to one exemplary embodiment. Search criteria related to a desired potential customer may be received from a portal (stage 810). A search engine may be used to search for the desired potential customer, represented by a compatible PMDA (an individual represented by a PMDA with specifications that are compatible with at least one search criterion) (stage 830), and a content server may present search results identifying information about an individual represented by the compatible PMDA (stage 840). A business plan may be developed based on the search results (stage 850). The business plan may be an inventory plan, a marketing plan, and/or a sales plan. Further, products or services may be developed to be tailored to the specifications of the PMDAs associated with the search results (stage 860).

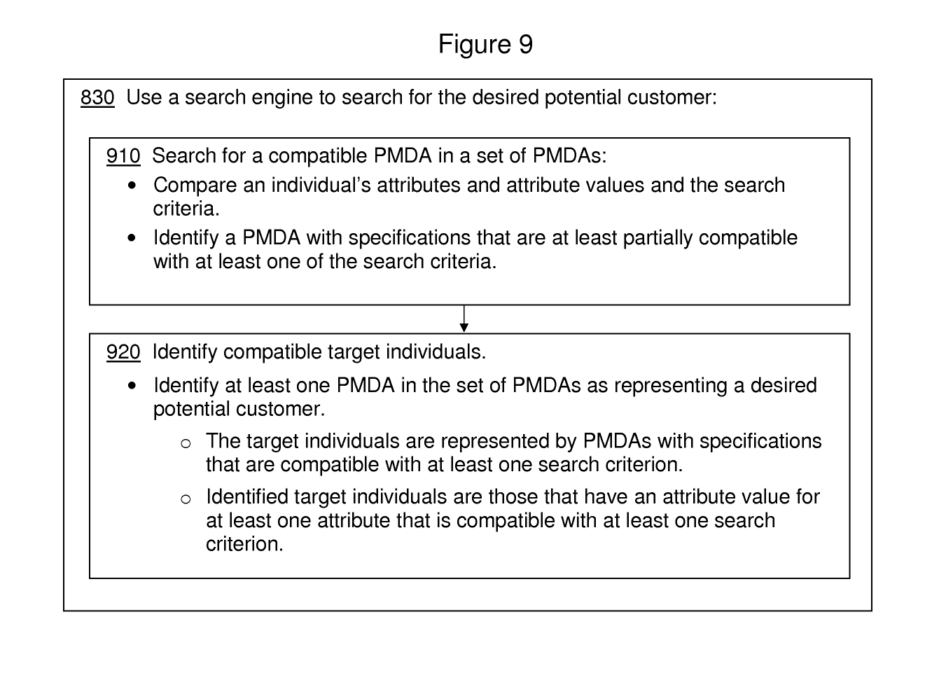

FIG. 9 is a flowchart depicting one embodiment of the stage 830 for using a search engine to search for the desired potential customer. The search for a compatible PMDA may be conducted within a set of PMDAs. An individual's attributes and attribute values may be compared to the search criteria in order to identify a PMDA with specifications that are at least partially compatible with at least one of the search criteria (stage 910). At least one compatible target individual may be identified as a desired potential customer (stage 920) by identifying at least one PMDA with specifications that are compatible with at least one search criterion. Identified target individuals may be those that have an attribute value for at least one attribute that is compatible with at least one search criterion.

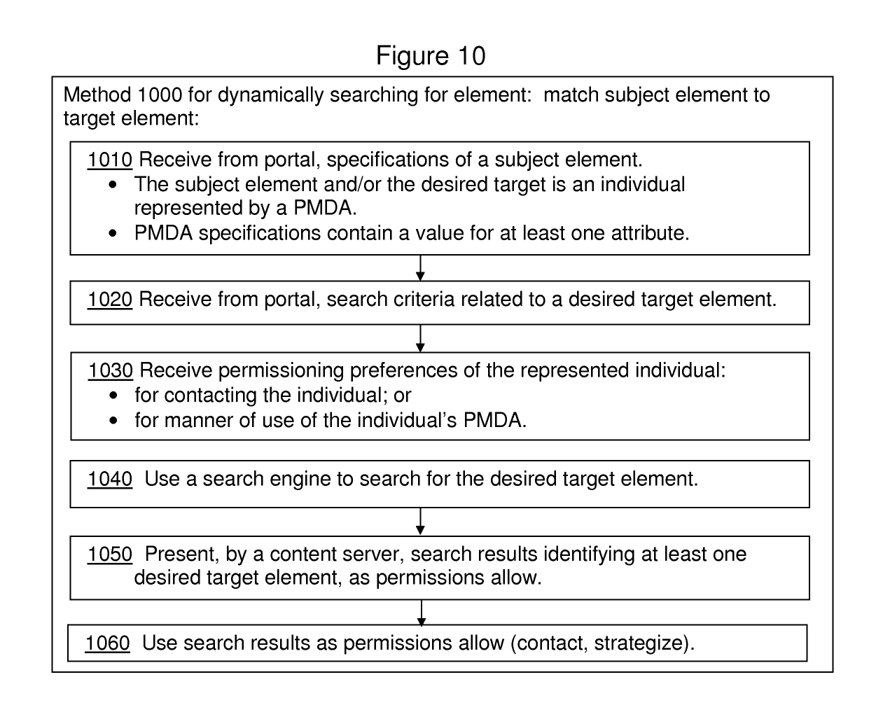

FIG. 10 shows an exemplary embodiment of a process 1000 for dynamically searching for elements in a computer based commerce system according to one exemplary embodiment. The specifications of a subject element may be received from a portal (stage 1010). An individual represented by a PMDA may be the subject element or the desired target. In one embodiment, individuals are both the subject element and the desired target. The PMDA specifications may contain a value for at least one attribute. Search criteria related to a desired target element may be received from a portal (stage 1020). In addition, permissioning preferences of the represented individual may be received (stage 1030). The permissions may establish an individual's preferences for contacting the individual or for manner of use of the individual's PMDA. As the permissions allow, a search engine may be used to search for the desired target element (stage 1040). As permissions allow, a content server may present search results identifying at least one desired target element (stage 1050). Further, as described in further detail above, the search results may be used as permissions allow (stage 1060).

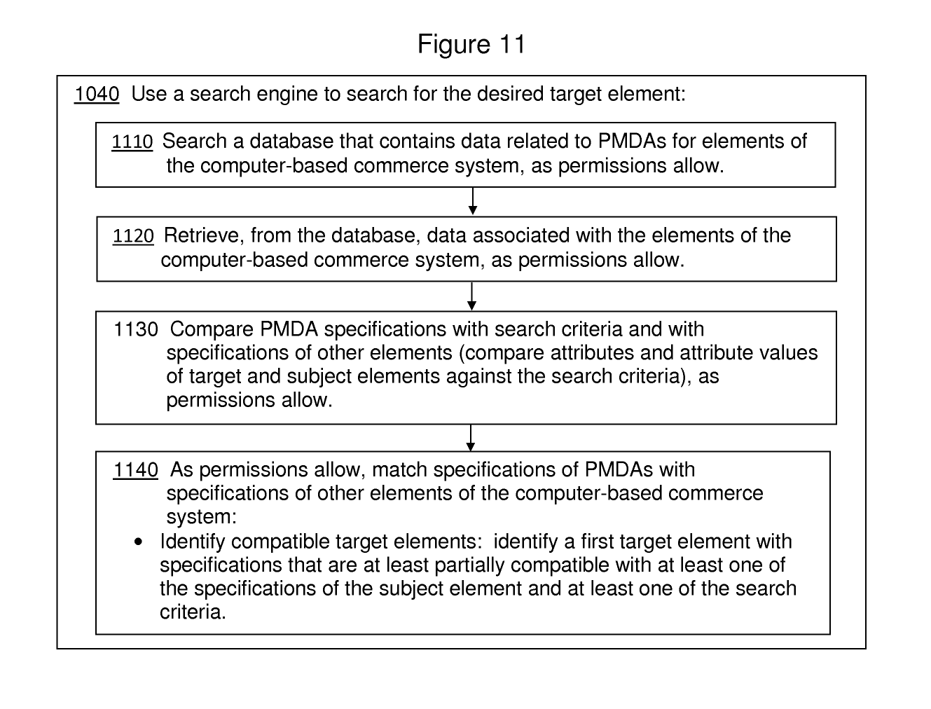

FIG. 11 is a flowchart depicting one embodiment of the stage 1040 for using a search engine to search for the desired element. A database that contains data related to PMDAs may be searched, as permissions allow (stage 1110), and data associated with the elements of the computer-based commerce system retrieved from the database, as permissions allow (stage 1120). PMDA specifications may be compared with search criteria and with specifications of other elements (by comparing attributes and attribute values of target and subject elements against the search criteria), again, as permissions allow (stage 1130). The specifications of PMDAs may be matched with specifications of other elements to identify compatible target elements, again, as permissions allow (stage 1140).

One of skill in the art will appreciate that the above-described stages may be embodied in distinct software modules. Although the disclosed components have been described above as being separate units, one of ordinary skill in the art will recognize that functionalities provided by one or more units may be combined. As one of ordinary skill in the art will appreciate, one or more of units may be optional and may be omitted from implementations in certain embodiments.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations may be implemented in software, hardware, or a combination of hardware and software. Examples of hardware include computing or processing systems, such as personal computers, servers, laptops, mainframes, and micro-processors. In addition, one of ordinary skill in the art will appreciate that the records and fields shown in the figures may have additional or fewer fields, and may arrange fields differently than the figures illustrate. It is intended that the specification and examples be considered as exemplary only, with a true scope and spirit of the invention being indicated by the following claims.

1. A method for dynamically searching for items in a computer-based commerce system, comprising:
receiving, from a portal, a personalized multi-dimensional avatar (PMDA) for an individual, wherein the PMDA has specifications that comprise at least one of the following aspects: characteristics of the individual, preferences of the individual, and measurements of parts of the individual;
receiving search criteria related to a desired item;
searching, by a search engine, for the desired item, further comprising
identifying target items having specifications that are at least partially compatible with at least one of the search criteria and at least one of the specifications of the PMDA, and
identifying sources for the target items; and
presenting, by a content server, search results for review by a party seeking the desired item, wherein the search results comprise information about the target items and information about the sources of the target items.

2. The method of claim 1, further comprising creating, from the search results, a virtual mall containing links to the sources to facilitate future access to the sources.

3. The method of claim 1, further comprising:
forwarding at least some of the search results to a software program in a mobile device; and,
based on the search results, identifying a geographic location of a first source of the desired item to identify a proximity of the first source to the party.

4. The method of claim 1, further comprising displaying an image of a first target item with the PMDA to display a simulation of how the first target item would operate with the individual, wherein displaying further comprises rendering the image of the first target item translucent to facilitate viewing of the first target item relative to the PMDA.

5. The method of claim 1, wherein the individual furthers comprises a human or an animal.

6. The method of claim 6, wherein the desired item further comprises a good or a service.

7. A method for dynamically searching for potential customers who seek items in commerce, comprising:
receiving, from a portal, search criteria related to a desired potential customer;
searching, by a search engine, for the desired potential customer,
wherein the searching further comprises identifying a compatible PMDA in a set of personalized multi-dimensional avatars (PMDAs),
wherein the PMDAs represent a set of individuals and have specifications, wherein a specification comprises at least one of the following aspects: characteristics of a represented individual, preferences of the represented individual, and measurements of parts of the represented individuals, and
wherein identifying the compatible PMDA comprises identifying a PMDA with specifications that are at least partially compatible with at least one of the search criteria; and
presenting, by a content server, search results for review by a party seeking the desired potential customer, wherein the search results comprise information about an individual represented by the compatible PMDA.

8. The method of claim 7,
wherein the search results comprises an identification of a set of individuals with PMDAs with specifications that are at least partially compatible with at least one of the search criteria, and
further comprising developing a business plan based on the search results.

9. The method of claim 8, wherein developing the business plan comprises developing at least one of the following plans: an inventory plan, a marketing plan, and a sales plan.

10. The method of claim 8, further comprising developing products or services tailored to the specifications of the PMDAs associated with the search results.

11. A method for dynamically searching for elements in a computer-based commerce system that matches a subject element to a target element, the method comprising:
receiving, from a portal, specifications of the subject element;
receiving search criteria related to a desired target element,
wherein at least one of the subject element and desired target element comprises an individual represented by a personalized multi-dimensional avatar (PMDA) having specifications that comprise at least one of the following aspects: characteristics of the represented individual, preferences of the represented individual, and measurements of parts of the represented individual,
receiving permissioning preferences of the represented individual for at least contacting the represented individual or using the specifications for the PMDA for the represented individual,
searching, by a search engine, for the desired target element, further comprising:
retrieving, from a database, data associated with the elements of the computer-based commerce system; and
comparing the specifications of the PMDA with the search criteria and with specifications of other elements of the computer-based commerce system to identify a first target element having specifications that are at least partially compatible with at least one of the specifications of the subject element and at least one of the search criteria; and
allowing contact of the represented individual or use of the specifications for the PMDA for the represented individual based on the permissioning preferences;
presenting, by a content server, search results for review by a party seeking the desired target element, wherein the search results comprise information about the first target element.

12. A method according to claim 11, further comprising refining the search results by conducting at least one of the following activities: updating the search criteria, updating the specifications of the subject element; inputting new search criteria; and updating the PMDA.

13. The method of claim 11, wherein both the subject element and the desired target element comprise individuals, and wherein searching further comprises comparing the specifications of PMDAs to identify individuals having PMDAs with specifications that at least partially match.

14. The method of claim 11, wherein the permissioning preferences include preferences of the represented individual as to the type of access to the PMDA that is allowed to the search engine.

15. The method of claim 11, wherein the permissioning preferences include preferences of the represented individual as to the type of contact with the represented individual that is allowed to parties.

16. A system for dynamically searching for items in a computer-based commerce system, the system comprising:
a processor;
a non-transitory computer-readable medium encoding instructions for dynamically searching for the items and for execution by the processor, the instructions including:
a portal for receiving search criteria related to a desired item and a personalized multi-dimensional avatar (PMDA) for an individual, wherein the PMDA has specifications that comprise at least one of the following aspects: characteristics of the individual, preferences of the individual, and measurements of parts of the individual; and
a search engine for searching for the desired item, wherein the search engine has instructions for:
identifying target items having specifications that are at least partially compatible with at least one of the search criteria and at least one of the specifications of the PMDA, and
identifying sources for the target items; and
a content server for presenting search results for review by a party seeking the desired item, wherein the search results comprise information about the target items and information about the sources of the target items.

17. A system for dynamically searching for potential customers who seek items in commerce, the system comprising:
a processor;
a non-transitory computer-readable medium encoding instructions for dynamically searching for the potential customers and for execution by the processor, the instructions including:
a portal for receiving search criteria related to a desired potential customer; and
a search engine for searching for the desired potential customer,
wherein the searching further comprises identifying a compatible PMDA in a set of personalized multi-dimensional avatars (PMDAs),
wherein the PMDAs represent a set of individuals and have specifications, wherein a specification comprises at least one of the following aspects: characteristics of a represented individual, preferences of the represented individual, and measurements of parts of the represented individuals, and
wherein identifying the compatible PMDA comprises identifying a PMDA with specifications that are at least partially compatible with at least one of the search criteria; and
a content server for presenting search results for review by a party seeking the desired potential customer, wherein the search results comprise information about an individual represented by the compatible PMDA.

18. A system for dynamically searching for elements in a computer-based commerce system that matches a subject element to a target element, the system comprising:
a processor;
a non-transitory computer-readable medium encoding instructions for dynamically searching for the elements and for execution by the processor, the instructions including:
a portal for receiving specifications of the subject element and search criteria related to a desired target element,
wherein at least one of the subject element and desired target element comprises an individual represented by a personalized multi-dimensional avatar (PMDA) having specifications that comprise at least one of the following aspects: characteristics of the represented individual, preferences of the represented individual, and measurements of parts of the represented individual;
a permission tracker:
for receiving permissioning preferences of the represented individual for at least contacting the represented individual or using the specifications for the PMDA for the represented individual, and
for allowing contact of the represented individual and use of the specifications for the PMDA based on the permissioning preferences; and
a search engine for searching, for the desired target element, wherein the search engine includes instructions for:
retrieving, from a database, data associated with the elements of the computer-based commerce system; and
comparing the specifications of the PMDA with the search criteria and with specifications of other elements of the computer-based commerce system to identify a first target element having specifications that are at least partially compatible with at least one of the specifications of the subject element and at least one of the search criteria; and
a content server for presenting search results for review by a party seeking the desired target element, wherein the search results comprise information about the first target element.

19. A computer program embodied on a non-transitory computer readable medium for dynamically searching for items in a computer-based commerce system,
wherein the computer program comprises modules encoding interrelated and interdependent processes, including a portal and a search engine, and
wherein the computer program is configured to perform a method comprising:
receiving, by the portal, a personalized multi-dimensional avatar (PMDA) for an individual, wherein the PMDA has specifications that comprise at least one of the following aspects: characteristics of the individual, preferences of the individual, and measurements of parts of the individual; and
receiving search criteria related to a desired item;
searching, by the search engine, for the desired item, further comprising:
identifying target items having specifications that are at least partially compatible with at least one of the search criteria and at least one of the specifications of the PMDA, and
identifying sources for the target items; and
presenting, by a content server, search results for review by a party seeking the desired item, wherein the search results comprise information about the target items and information about the sources of the target items.

20. A computer program embodied on a non-transitory computer readable medium for dynamically searching for potential customers who seek items in commerce,
wherein the computer program comprises modules encoding interrelated and interdependent processes, including a portal and a search engine, and
wherein the computer program is configured to perform a method comprising:
receiving, from the portal, search criteria related to a desired potential customer;
searching, by the search engine, for the desired potential customer,
wherein the searching further comprises identifying a compatible PMDA in a set of personalized multi-dimensional avatars (PMDAs),
wherein the PMDAs represent a set of individuals and have specifications, wherein a specification comprises at least one of the following aspects: characteristics of a represented to individual, preferences of the represented individual, and measurements of parts of the represented individuals, and
wherein identifying the compatible PMDA comprises identifying a PMDA with specifications that are at least partially compatible with at least one of the search criteria; and
presenting, by a content server, search results for review by a party seeking the desired potential customer, wherein the search results comprise information about an individual represented by the compatible PMDA.

21. A computer program embodied on a non-transitory computer readable medium for dynamically searching for elements in a computer-based commerce system that matches a subject element to a target element,
wherein the computer program comprises modules encoding interrelated and interdependent processes, including a portal, a permission tracker, and a search engine, and
wherein the computer program is configured to perform a method comprising:
receiving, by a portal, specifications of the subject element;
receiving search criteria related to a desired target element,
wherein at least one of the subject element and desired target element comprises an individual represented by a personalized multi-dimensional avatar (PMDA) having specifications that comprise at least one of the following aspects: characteristics of the represented individual, preferences of the represented individual, and measurements of parts of the represented individual,
receiving, by the permission tracker, permissioning preferences of the represented individual for at least contacting the represented individual or using the specifications for the PMDA for the represented individual,
searching, by the search engine, for the desired target element, further comprising:
retrieving, from a database, data associated with the elements of the computer-based commerce system; and
comparing the specifications of the PMDA with the search criteria and with specifications of other elements of the computer-based commerce system to identify a first target element having specifications that are at least partially compatible with at least one of the specifications of the subject element and at least one of the search criteria; and
allowing contact of the represented individual or use of the specifications for the PMDA for the represented individual based on input from the permission tracker.
